(19) United States
(12) Patent Application Publication
(10) Pub. No.: US 2009/0019797 A1
(43) Pub. Date: Jan. 22, 2009

(54) Simplified Protective Cover Assembly

(76) Inventor: Cameron Todd Gunn, Miami, FL (US)

Correspondence Address: CAMERON GUNN, 19836 W. LAKE DRIVE, MIAMI, FL, 33015, US

(21) Appl. No.: 11/780,264

(22) Filed: Jul. 19, 2007

(51) Int. Cl. E06B 3/30

(52) U.S. Cl. 52/202

(57) ABSTRACT

A simplified protective cover assembly used to cover and protect openings such as doors, windows, or other openings for homes, office building, commercial buildings, and other wall structures from the destructive forces of a severe storm such as a hurricane. The current form of the preferred embodiment consists of high strength fabric covering an opening and be supported by steel bar and circular tube and being attached to wall. Once installed, the high strength fabric is stretched over the opening using a lever and pin. The high strength fabric, once stretched, will provide protection form high winds and wind borne debris common in storms such as hurricanes. There are additional features presented in the patent that will hide the simplified protective cover as well as turn into an awning which can reduce the heat into the house during summer months and reduce electric bills.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A “MICROFICHE APPENDIX”

“Not Applicable”

### BACKGROUND OF THE INVENTION

(1) Field of the Invention

The present invention relates to windborne or propelled debris protection equipment such as hurricane shutters or storm shutters, which protects wall openings or window, for example, from violent storms.

(2) Description of the Related Art

Hurricanes, Cyclones, Tornados or other violent storms have caused enormous damage to homes, businesses, and structures due to the high winds and the subsequent windbome debris. In particular Hurricanes, have become more of a concern in recent years with the increased construction of homes in coastal areas of the United States of America. The coastal areas are the most susceptible to the hurricanes and to it's destructive forces. There are several types of protection on the market. The simplest form of hurricane protection for a building is metal hurricane shutters. They are basically corrugated metal that are attached over the window. The basic premise is to protect the building from over pressurization as well as keep the wind and rain from entering the building. Since the glazing, in the window, is the most fragile, it required to be protected from windborne debris associated with a violent storm such as a hurricane. If the windows are not protected, debris such as roofing tile, can penetrate the window and allow wind and rain to enter the building. The wind can be powerful enough to blow the roof off once the window has been broken. This causes enormous damage to the building and can cause deaths.

The problem with hurricane storm panels or shutters, is that they are heavy and difficult to install. They will take a homeowner a full day to install shutters on his/her home. Due to difficulty with the installation, the shutters are often left on the home during the entire hurricane season. The shutters, left on during the hurricane season, have caused deaths in the past. If a fire breaks out in the home, the residents can be trapped in the home, due to the shutters.

Storm Panels are either galvanized or aluminum steel corrugated steel panels that are installed over the window. The advantages of this system is that they are relatively inexpensive. The disadvantage of this system is that they are not easily installed due to heavy weight and size and are time consuming to install.

There are other types of protection on the market such as accordion shutters, rolldown, bahama shutters which are based on a metal material. They are inherently expensive to purchase as well as being difficult to install.

Accordian Shutters are generally made of Aluminum that form an accordion shape when opening and closing. The advantage of this system is the ease of operation and they are generally permanently attached for which requires no installation prior to the storm. The disadvantage of this system is that it often does not match the exterior design of the building and the cost is significantly more than Storm Panels.

An example of an accordion shutter is in the U.S. Pat. No. 5,957,185 by Robinson and Tillit, Sep. 28, 1999 with their deployable and stackable accordion shutter system. The merits of this invention are that it can be deployed quickly and easily and not take up much space within the window space. As stated above the cost of this type of shutter are expensive. In addition, the shutter is solid and does not allow light to enter the building. This is an depressing and irritating thing for the homeowners who live in a cave.

In recent years, there has been several hurricane products that utilize a fabric material and have been patented. U.S. Pat. No. 6,325,085, by Gower utilizes a fabric that is anchored above and below the window usually anchored to the ground and place at an incline to ground. The fabric is to the wall using straps or some other method. The fabric hurricane protection is installed when a hurricane is approaching and is removed after the hurricane has passed. The fabric system is not stretched nor is it tight in any way. The fabric forms the necessary barrier to protect the window opening from wind borne debris as intended.

Another invention, which is comparable to the present invention is U.S. Pat. No. 6,886,300, Hudoba, dated May 3, 2005 which utilized a frame and fabric which is stretched within a frame and is installed as storm panel would be installed. The panel is made of fabric and has several features such as being light weight and could be installed on tracks or directly to the wall. The fabric and frame would then be stored when not in use.

There are several differences between this patent and present invention in that the fabric is stretched using a rod and lever arm with a pin that will keep the fabric tight after being installed. The present invention will roll up and can be covered with covering if the home owner requests. The present invention will be rolled up and placed into a tube or box when not in use. The present invention involves installing the invention and then tightening the fabric while on the wall creating strong barrier. The prior art acts like a storm panel except it is a steel frame with fabric in the middle.

Another U.S. Pat. No. 6,341,455, by Gunn, introduces a new type of hurricane protection that rolls up and is stretched to form a strong barrier against wind borne debris. This device does meet some of the requirements. The invention has the ease of use since it rolls up into a nice covering over the window. The invention allows light into the home since the fabric is translucent.

There are no specific prior art that is similar to the present invention in the specific design and purpose. The closest prior art to is the invention done by Cameron Gunn, U.S. Pat. No. 6,325,085, which involves stretching a fabric over the window and rolling it up into the covering. The present invention has some similar features, however has been developed as lower cost alternative and more similar to the storm panels. The preferred embodiment is a simple approach to protecting the home and has many features that are considered desirable.

The present invention has been developed as a low cost alternative to all other hurricane protection devices out on the market and competes with the lowest cost alternative to the galvanized panels. The primary problem of mitigation of disasters is the cost of the protection. The home owner or building owner will look at the risk and the frequency of the risk and determine what an acceptable cost to prevent the disaster is. The less the cost, the more likely the building owner will purchase the mitigation device. The important feature of the preferred embodiment is the low cost and the known performance of the high strength fabric.

The present invention also allows the user to store the product in housing so that it will not have to be stored. If the present invention is stored, it can be rolled up into a tight roll and stored easily. The present invention could also utilize a flexible high strength material such as a high strength fabric that is transulant so that during a severe storm and present invention is being used, the user will not have to be in the dark during the severe storm. In the case of a hurricane, the present invention could be installed several days before the hurricane can arrive and the user will not be in the dark.

The preferred embodiment of the invention is comprised of high strength fabric that is light weight. The current problem with the existing products, in particular, the storm panels is that they are heavy and bothersome to install. In addition, due to their weight, they are dangerous when product slips out the hands of the user. The light weight feature of the present invention provides an advantage to existing products in the market.

In order to produce a product for the hurricane protection industry, there are standardized testing requirements for the protective devices to meet for strength and integrity. The tests are designed to simulate the hurricane wind force winds and to simulate flying debris in a hurricane. The primary purpose of the standardized testing requirements or codes is to ensure that the hurricane protection on the home is suitable for the service and will protect the home and the occupants.

### BRIEF SUMMARY OF THE INVENTION

The invention relates to an original design for an exterior covering of wall openings for use in protecting all wall openings in buildings from severe wind and rain damage or from windbome debris objects during violent storms, such as hurricanes. The design involves using a flexible high strength material such as high strength fabric that is stretched over the wall opening utilizing various methods to stretch the fabric to provide a protective barrier. The invention also relates to similar design within the window frame to combine the protective barrier with window frame. This combined feature can also be used as an exterior window shade.

The general purpose of the present invention, which will be described subsequently in greater detail, is to provide a protective cover assembly which has many of the advantages of the existing shutters mentioned, heretofore and many novel features that result in a new protective cover assembly which is not anticipated, rendered obvious, suggested, or implied by any of the prior art.

There has been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to details of construction and to the arrangement of the components set forth in the following description or illustrated in the drawings. The invention is capable of other embodiments and of being carried out in various ways. Also, it is understood that the phraseology and terminology employed herein are for the purpose of the description and should not be regarded as limiting.

Further, the purpose of the foregoing abstract is enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

A high strength flexible material, such as a high strength fabric is secured at the top of window using an anchoring system and at the bottom of the window there are brackets and a circular rigid member which is connected to the fabric and the rigid circular member is attached to the wall. The anchors and brackets connect the assembly to the wall in the preferred embodiment. In this application the entire assembly will be marginally larger than the window opening. Once all the components are installed, then the user will use a lever to turn the bottom tube a specified length thus tightening the fabric over the opening to form a strong barrier. The tube is then locked into the place with a pin in the preferred embodiment. There are alternative embodiments presented that will lock the tube in place after being turned. There are alternative embodiments that will also stretch the fabric.

Once the bottom tube is turned and locked into place, there is a strong barrier over the opening which will protect it from flying debris. The barrier will also resist wind in the case of a hurricane, tornado or severe storm.

There are alternative embodiments presented as it relates to the installation of the assembly, covering of the assembly, and integration into a window frame or opening. In addition, the preferred embodiment can be installed sideways and upside down according the to needs of the user and architectural preference.

There is one additional feature of the present invention is that it can be used as an awning when employing the awning option. There are users that may wish to utilize the hurricane protection as awning to add value to their structure. It is a relatively small investment to utilize both and the present invention offers this feature.

### BRIEF DESCRIPTION OF THE SEVERAL VIEWS OF THE DRAWINGS

FIG. 1—is the three dimensional view of the installed preferred embodiment of the protective cover, over a window on a residential house in the protective mode or in the closed position.

FIG. 2—is an exploded three dimensional view of the preferred embodiment of the protective cover showing how the components go together on the side of a house.

FIG. 3—is a three dimension detail view of the preferred embodiment locking mechanism of the tube using a pin and eyebolt.

FIG. 4—is a three dimensional detail view of an alternate embodiment locking mechanism of the tube using the lever and a separate bracket with a pin.

FIG. 5—is an exploded three dimensional view of an alternate embodiment of the invention where there are brackets on the top and bottom to place out from the wall further.

FIG. 6—is detailed three dimensional view of the alternative embodiment locking mechanism of the tube using a ratcheting system which does not allow the rotation of the tube.

FIG. 7—is 2 dimension front and side view of the ratchet and pawl assembly.

FIG. 8—is a three dimensional view of the preferred embodiment with the brackets located on the top and with additional supports to form an awning for the window while utilizing the protective features of the invention

FIG. 9—is a three dimensional view of the preferred embodiment of the invention when utilizing the alternative feature of the awning.

FIG. 10—is an exploded three dimensional view of the alternate embodiment locking mechanism using a ratcheting system.

FIG. 11—is 3 dimensional view of an alternative method of stretching the fabric using a ratcheting tool that clamps on the bottom and pulls down allowing the bottom member to be attached to the wall at the correct location.

FIG. 12—is a 2 dimensional view of the fabric showing how the preferred embodiment of the fabric is being sewn to have pouches for the components.

FIG. 13—is a 3 dimensional view of the assembly with a cover used to contain the assembly when not in use.

FIG. 14—is a 3 dimensional view of the assembly cover of the preferred embodiment showing a hinged section.

FIG. 15—is a 3 dimensional view of the fabric tube of the preferred embodiment and attachedment of the fabric to tube using a slot in the fabric tube and using a fabric rod.

FIG. 16—is a 3 dimensional view of the high strength fabric and the awning material showing how the awning would go over the high strength fabric when the option for the awning is utilized.

FIG. 17—is a 3 dimensional view of the assembly on the house where there are grommets on the top of the fabric which is attached to the wall and there is not rigid member at the top.

FIG. 18—is a 3 dimensional view of the assembly on the house where there is a heavy bar on the bottom to stretch the fabric into place as an alternative embodiment.

FIG. 19—is a 3 dimensional view of the assembly that is integrated into a window frame utilizing the same components.

FIG. 20—is a 3 dimensional view of a standard window.

FIG. 21—is a 3 dimensional exploded view of the simplified protective cover assembly integrated into the window frame in the open position or not in use position.

FIG. 22—is a 3 dimensional view of the simplified protective cover assembly integrated into the window frame in the closed position or operational position.

FIG. 23—is a 3 dimensional exploded view of the simplified protective cover assembly integrated into the window frame with a motor drive to lower and raise the fabric.

### DETAILED DESCRIPTION OF THE INVENTION

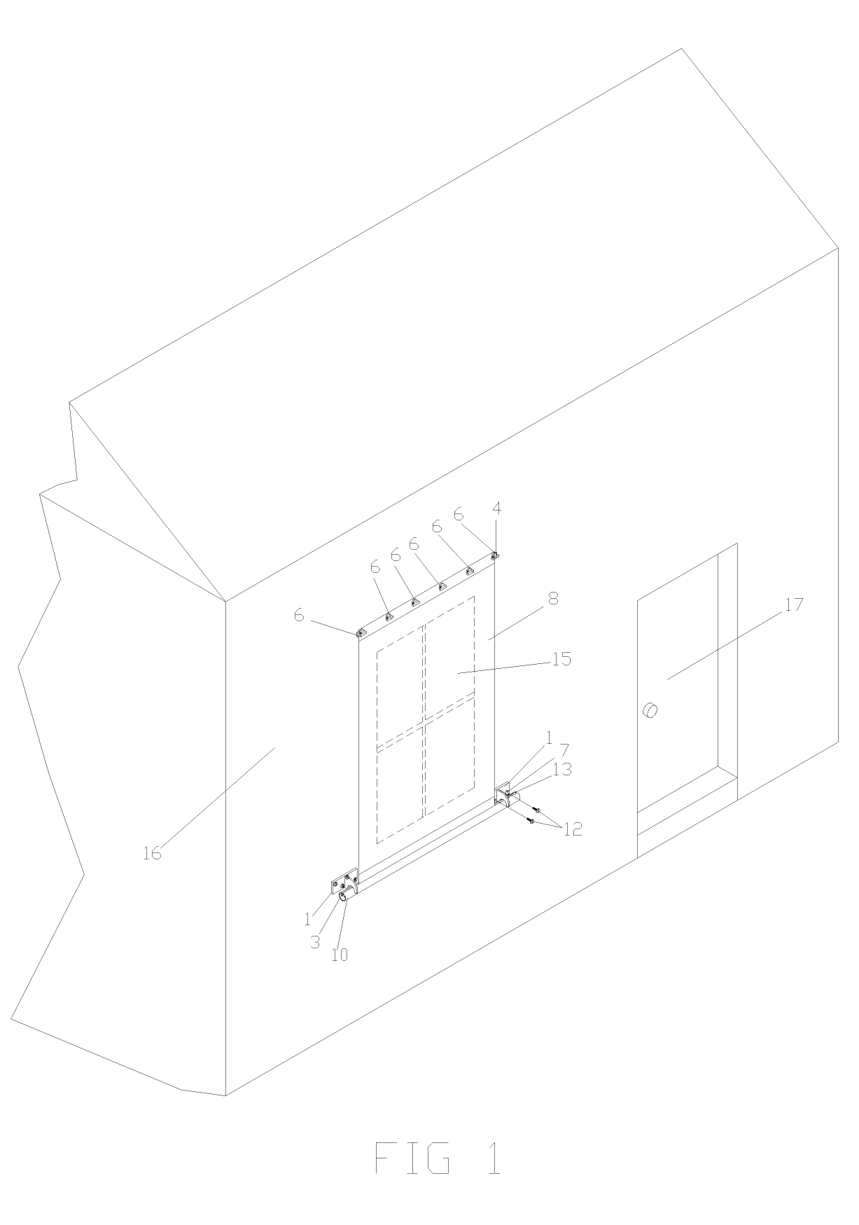

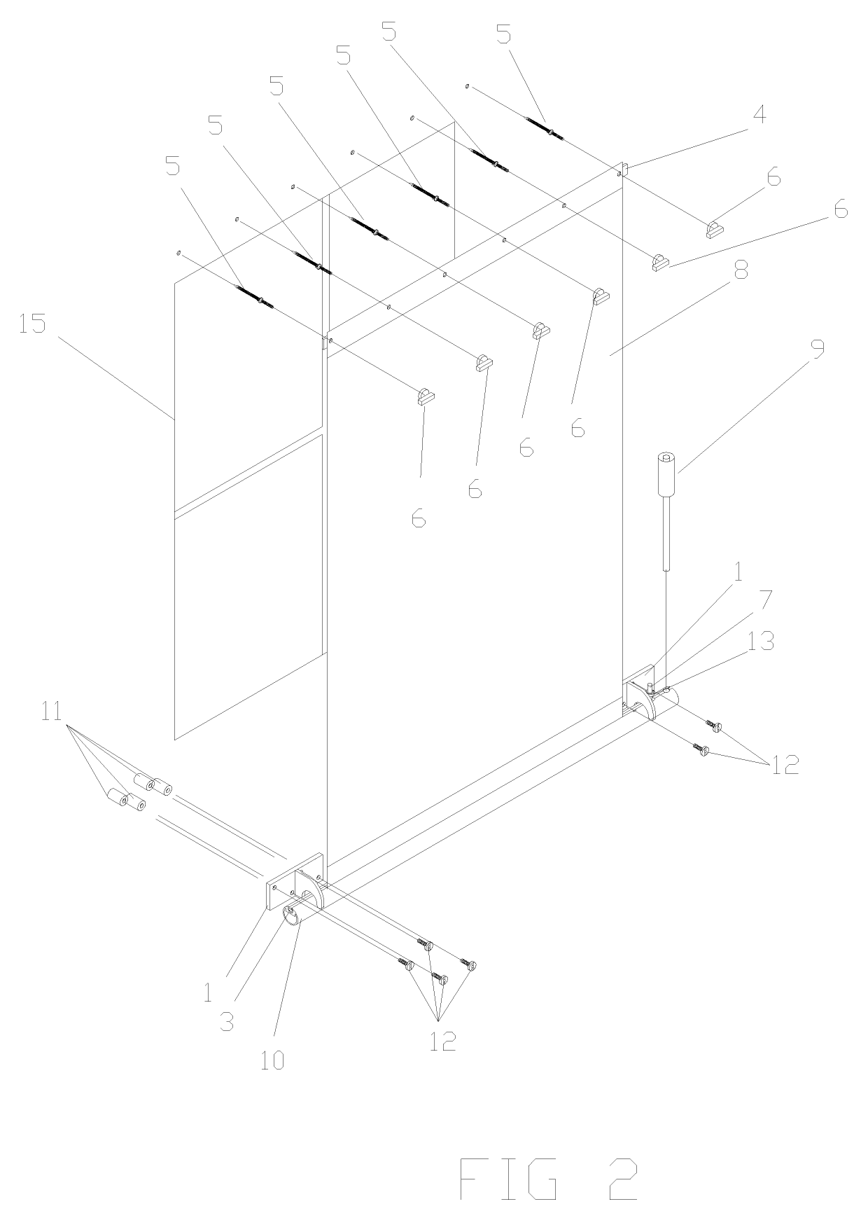

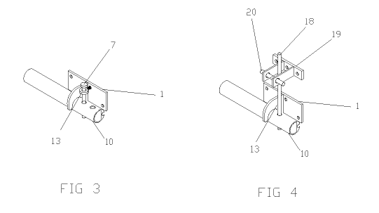

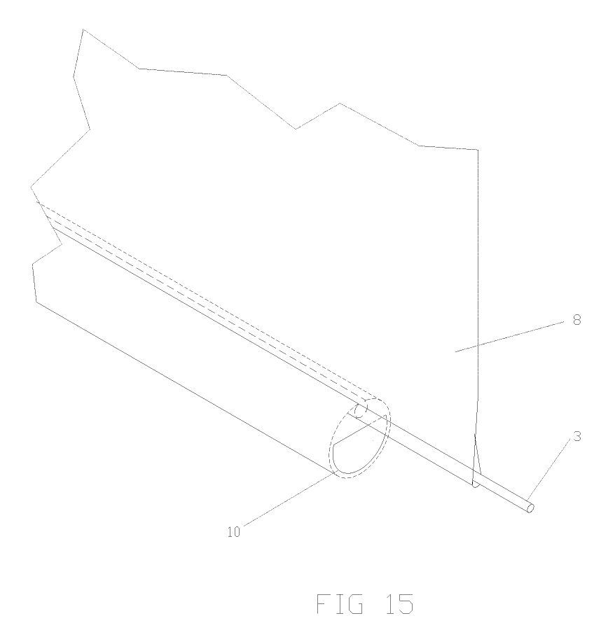

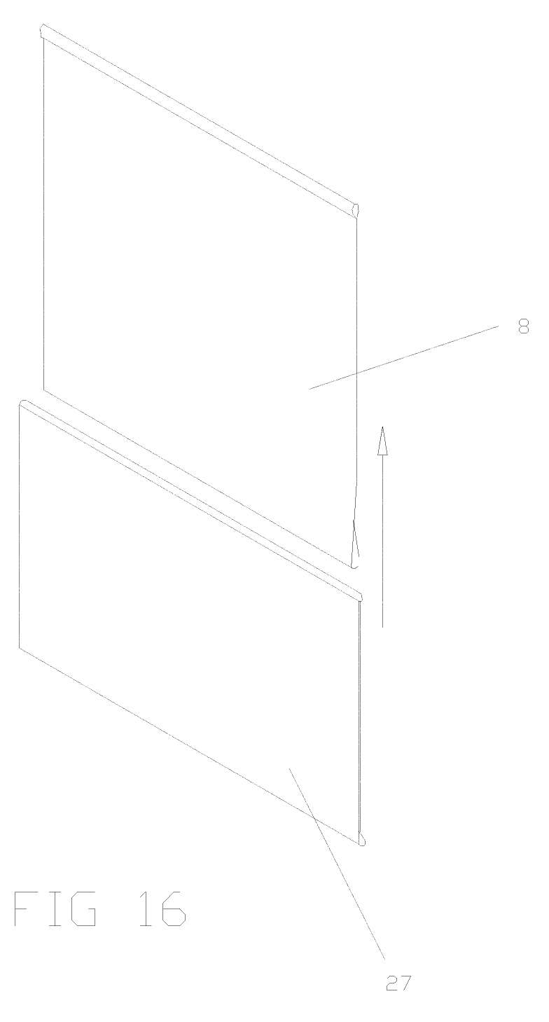

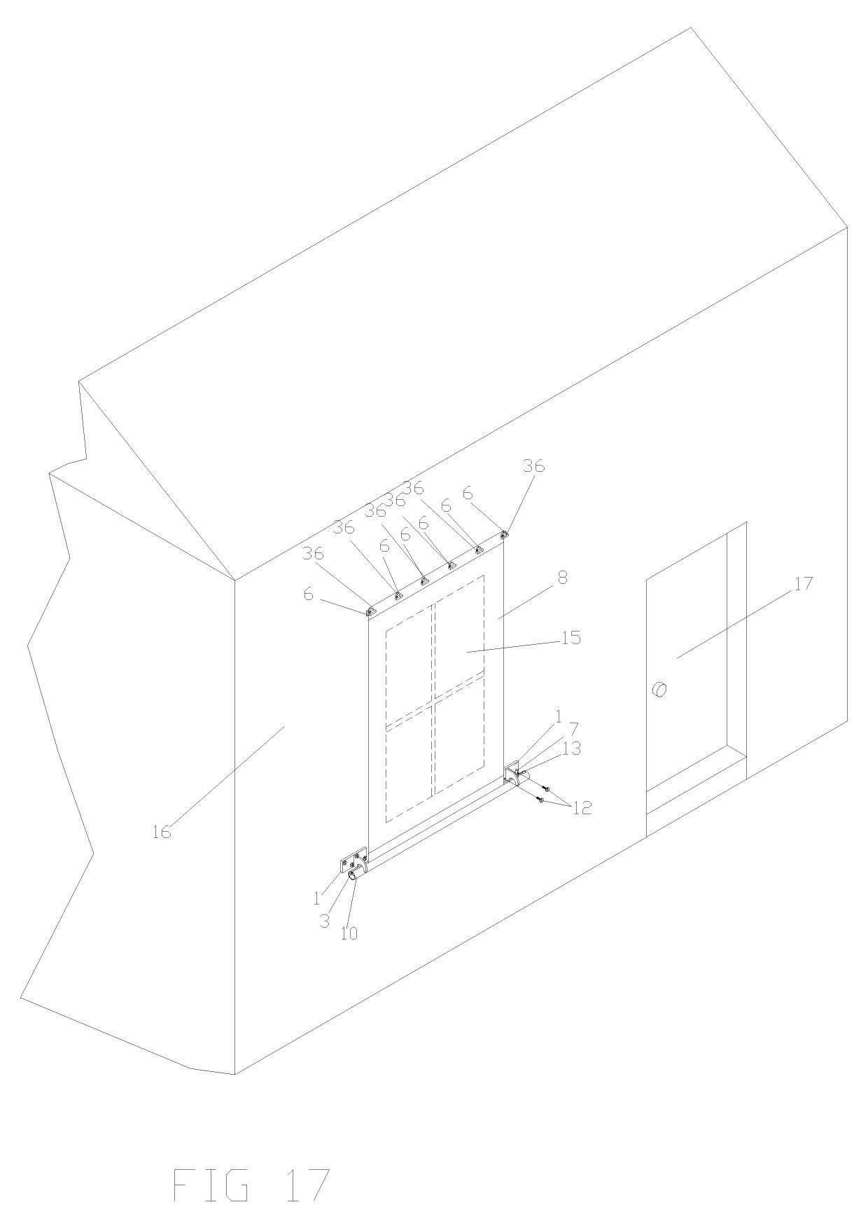

A simplified protective cover assembly for wall openings which embodies the concepts of the preferred embodiment of the invention is illustrated in FIG. I representing a single protective covering over a window at a house. The protective cover can be various sizes to cover the various sizes such as sliding glass doors, doors or windows, and is shown on one type of window in the drawing for illustration purposes and one form of the present invention. The simplified protective cover assembly of the preferred embodiment of the invention includes a high strength fabric 8, a fabric rod 3, near wall brackets 1, rectangular bar 4, fabric tube 10, wing nuts 6, bar anchors 5, anchors 11, anchor screws 12, eyebolt 13, and pin 7. The materials to be used for the simplified protective cover assembly are only limited by their strength, weather resistance, weight and costs. The new wall brackets 1, fabric rod 3, rectangular bar 4, wing nuts 6, lever 9, eyebolt 13, pin 7, anchors 11 and bar anchors 5 can be plastic, composite, or metal. The preferred materials for these items is metal and for most parts aluminum is preferred due the corrosion resistance and light weight. The high strength fabric 8 can come a variety of materials such polypropylene, Kevlar, geomembranes, permalon, polyester, spectra and other high strength fabrics. The simplified protective assembly is typically placed on the exterior of the building but first installing the bar anchors 5 on the top of the opening in measure locations and installing the anchors 6 at the bottom of the wall opening. The anchors 5 are installed by drilling a hole into the wall 16 and insert anchor 5 into the hole. The bar anchors 5 are installed by drilling a hole in the wall 16 and then drilling the bar anchors 5 into the drilled hole. The high strength fabric 8 is slide into the slot with the fabric rod 3 that is located in fabric tube 10 which is illustrated in FIG. 15. The high strength fabric 8 is connected to the fabric tube 10 once the high strength fabric 8 is slide through the entire fabric tube 10. On the top of the high strength fabric 8, there is a slot in the high strength fabric 8 and the rectangular bar 4 is slide into the high strength fabric 8 and aligned with the holes that are in the high strength fabric 8 and the holes in the rectangular bar 4. The near wall brackets 1 are attached the wall 16 by placing the near wall bracket 1 on the wall 15 with the holes of the near wall bracket 1 aligning with anchors 11 and then using anchor screws to attach near wall bracket 1 to the wall 16 which is also illustrated in FIG. 2. Once the near wall brackets I are attached to the wall 15, then the fabric assembly with the rectangular bar 4 inserted, and the high strength fabric 8 attached to the fabric tube 10 is lifted so that the fabric tube 10 is inserted into the near the wall brackets I and lifted so that the holes the rectangular bar 4 holes are place on the bar anchors 5 which are protruding from the wall 15. Once the rectangular bar 4 is in place which is also illustrated in FIG. 2, the wing nuts 6 will be placed on the bar anchors 5 thus attaching it to the wall 16. Once all the wings nuts 6 are placed as shown in FIG. 2, the high strength fabric 8 is ready to be stretched using lever 9. Lever 9, as shown in FIG. 2, will be placed into a hole in the fabric tube 10. Once the lever 9 is placed into a hole in fabric tube 10, the lever 9 is pushed upwards and thus rotating the fabric tube 10 and tightening the fabric. In FIG. 3, the preferred embodiment of the locking mechanism of the tube is shown. Once the fabric tube 10 is rotated it is locked into place, therefore maintaining tightness, buy placing the pin 7 through the eyebolt 13 and fabric tube 10 thus locking the fabric tube 10 in place. The high strength fabric 8 is now taunt or drum like so that flying debris or wind will be repelled. In FIG. 17, the assembly is exactly the same as FIG. 1, however there is no rectangular bar 4 and there is grommets 36 place in the fabric which greats holes so that high strength fabric 8 is attached to wall using bar anchors 5 and wing nut 6. There are several methods to lock the fabric tube 10 in place and the present invention has alternative embodiments however does not preclude from other forms of locking the fabric in place. In FIG. 4, the alternative embodiment is presented for locking the fabric tube 10 into place. In this alternative embodiment a permanent lever 18 is utilized in the place of pin 7 as in FIG. 3. In alternative embodiment a permanent lever 18 is turned upwards and locked into place using permanent lever pin 20 and permanent lever bracket 19. The permanent lever bracket 19 would be installed onto the wall using anchors 11 and anchor screws 12 similar the way the near wall brackets I were installed in FIG. 2. In this alternative embodiment the permanent lever 18 will always be attached.

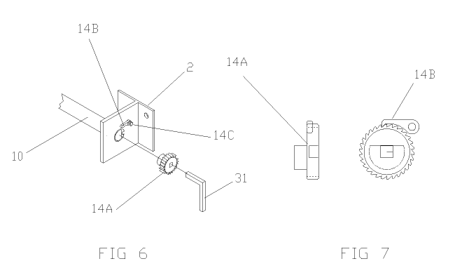

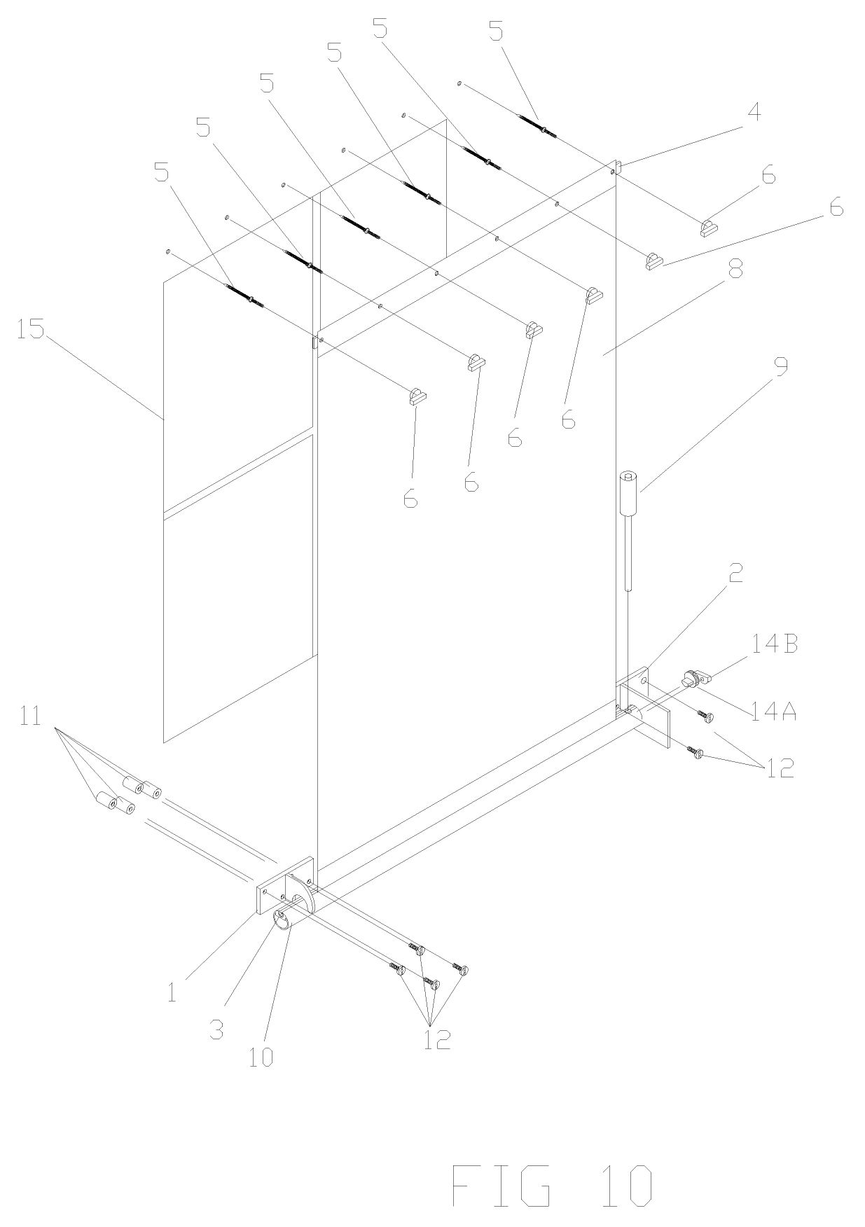

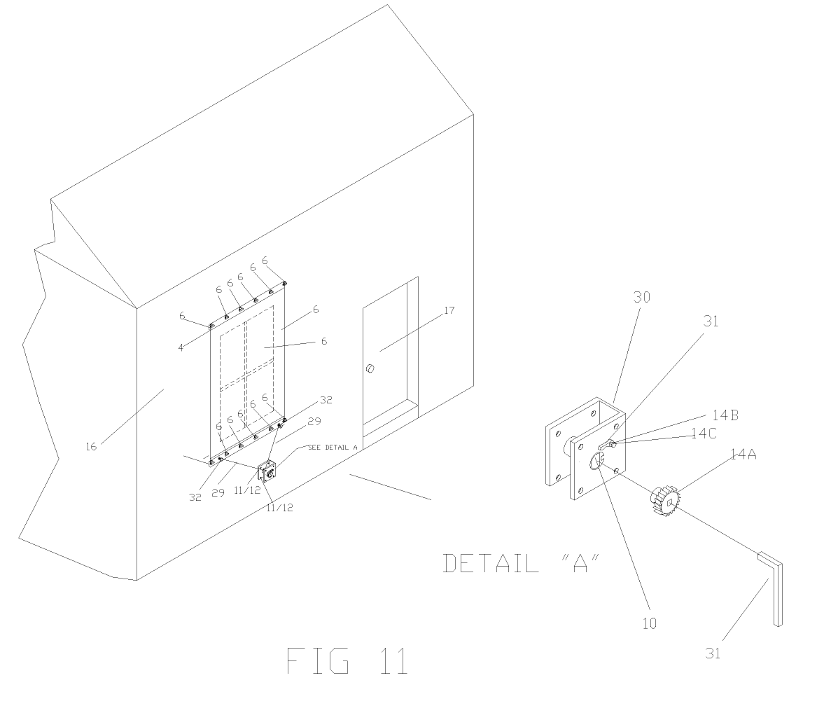

In FIG. 6, another alternative embodiment is presented, is a 3 dimensional view a ratchet system which comprises of ratchet wheel 14A, pawl 14B, shoulder screw 14C and ratchet bracket 2. As seen in FIG. 6, the ratchet wheel 14A would fit into the fabric tube 10 to make a connection of the fabric tube 10 to the ratchet wheel 14A. The fabric tube 10 would rotate within the ratchet bracket 2 by turning the ratchet wheel 14A with the ratchet handle 31. By turning the ratchet wheel 14A, the fabric tube 10 would rotate and tighten the high strength fabric 8. Once the high strength fabric 8 is tightened the pawl 14B would engage the ratchet wheel 14A and not allow for reverse motion. This would essentially lock the fabric tube 10 in place and keep the high strength fabric 8 in tension and protecting the opening. The pawl 14B is attached the ratchet bracket 2 through the use of a shoulder screw 14C. The ratchet bracket 2 would be placed on the wall 16 the same wall that the near wall brackets 1 with anchors 11 and anchor screws 12 as shown in FIG. 10. FIG. 10 is an exploded 3 dimension view of the simplified protective cover assembly with the ratchet wheel 14A, ratchet bracket 2 and pawl 14B. In FIG. 10, the only difference between FIG. 1 and FIG. 10 is the alternative embodiment as shown in FIG. 6 is replacing the preferred embodiment shown in FIG. 3.

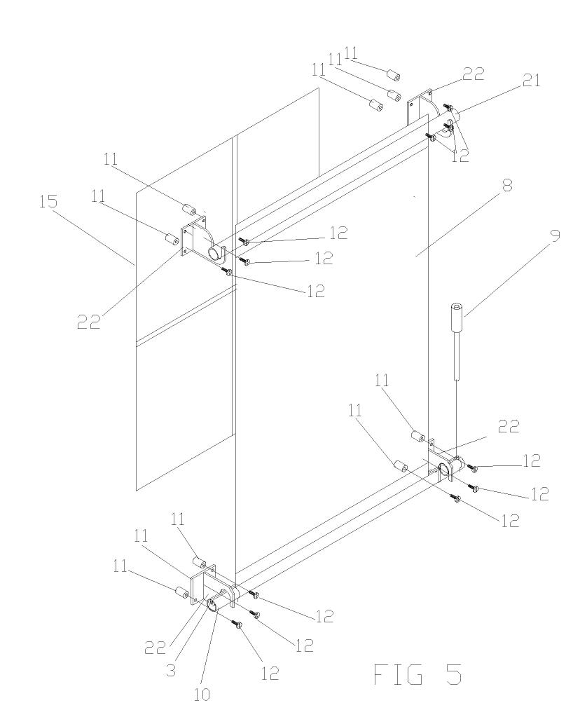

In FIG. 5, there a 3 dimensional alternative embodiment of the assembly which is further off the wall for different code requirements. The anchors 11 are placed into the wall 16 as described in FIG. 1 using a drill and placing the anchors 11 into the holes. This done in all locations indicated in FIG. 5. The high strength fabric 8 is slide onto fabric tube 10 as shown in FIG. 15 using fabric rod 3. The top of the high strength fabric 8 has a opening so that the tube extended 21 can be slide into to the high strength fabric 8. The top extended brackets 22 are installed onto the wall 16 by aligning the anchors 11 with the holes in the extended brackets 22 and placing anchor screws 12 into the anchors 11 thus attaching the extended brackets 22 to the wall 16. Then lifting the fabric assembly which included high strength fabric 8, fabric rod 3, tube extended 21, the extend tube 21 is placed in the extended brackets 22 where the assembly will hang. Now the bottom extended brackets 22 will be attached to the wall 16 using anchor screws 12 with fabric tube 10 in the extended brackets 22. Once all the anchor screws 12 are installed as shown in FIG. 5, the fabric tube 10 is rotated with the lever 9 and locked into place with pin 7 as shown in FIG. 3. The high strength fabric 8 is now taunt and drums like to resist all flying debris and wind.

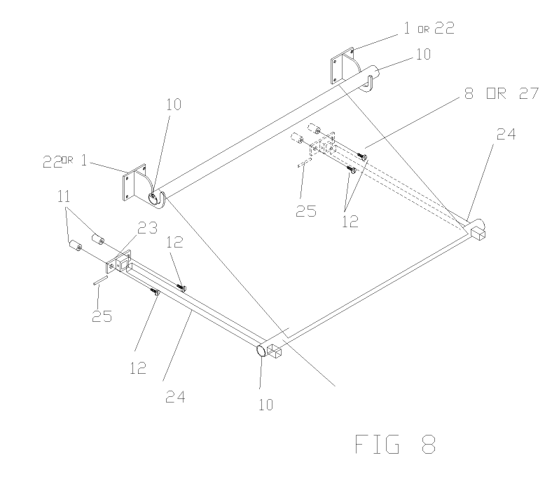

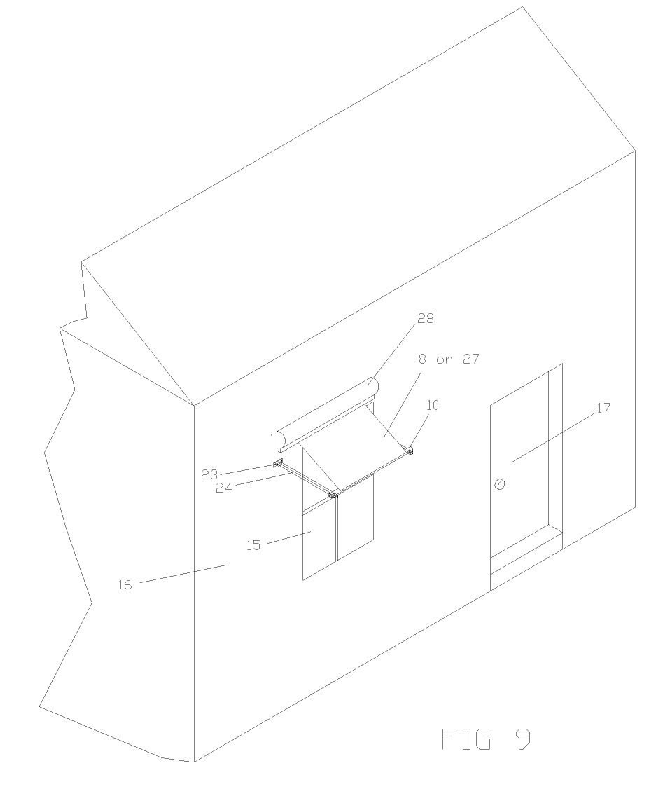

In FIG. 8, there is 3 dimensional view of conversion of the simplified protective cover assembly to an awning utilizing many of the same components. The fabric tube 10 is located on the top in the near wall brackets 1 where the high strength fabric 8 is rolled up a little longer than final location for awning and locked into place as done FIG. 3 with pin 7 and eyebolt 13. After the high strength fabric 8 is rolled up on fabric tube 10 to specified height an awning fabric 27 that is sewn similar to pillow case is place over the high strength fabric 8 and then attached to another fabric tube 10 as the shown in FIG. 15 except the awning fabric 27 is place in the slot. Then the top fabric tube 10 is rotated using the lever 9 to the specified height while rotating the awning fabric 27 around the top fabric tube 10. The awning brackets 23 are attached to the wall using anchors 11 and anchor screws. The awning bar 24 is placed into the awning brackets 23 and secured in place by the awning pin 25 and the other end of the awning bar 24 is connected to the bottom fabric tube 10 through pressure fit holes. A protective cover 28 as shown in FIG. 9 which is a 3 dimensional drawing of the awning option on the house. The added feature of an awning makes the hurricane protection device more attractive on the house as well has reduces the heat entering the house during the summer thus reducing the energy bills.

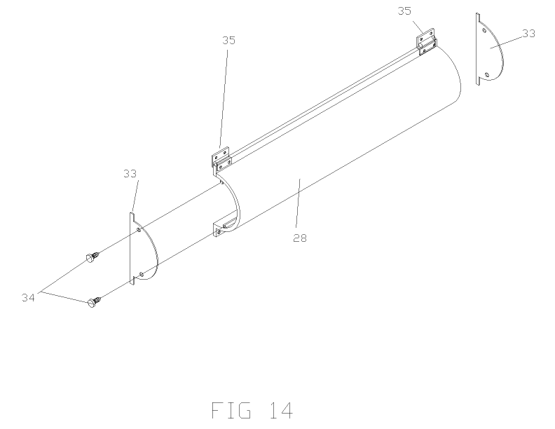

FIG. 14 is 3 dimensional drawing showing the preferred embodiment of the assembly cover 28 which consists of an aluminum extruded piece with screw bosses and end cover plates 33 which can be screwed into assembly cover 28. In addition, the assembly cover is attached the wall using hinges 35 which are also attached the assembly cover 28. The hinge 28 allows the assembly cover 28 to open up and be able to place the simplified protective cover assembly in for storage. The hole in the bottom of the assembly cover 28 is to fasten to wall using anchor 11 and anchor screws 12 when in storage as well has hold open the assembly cover 28.

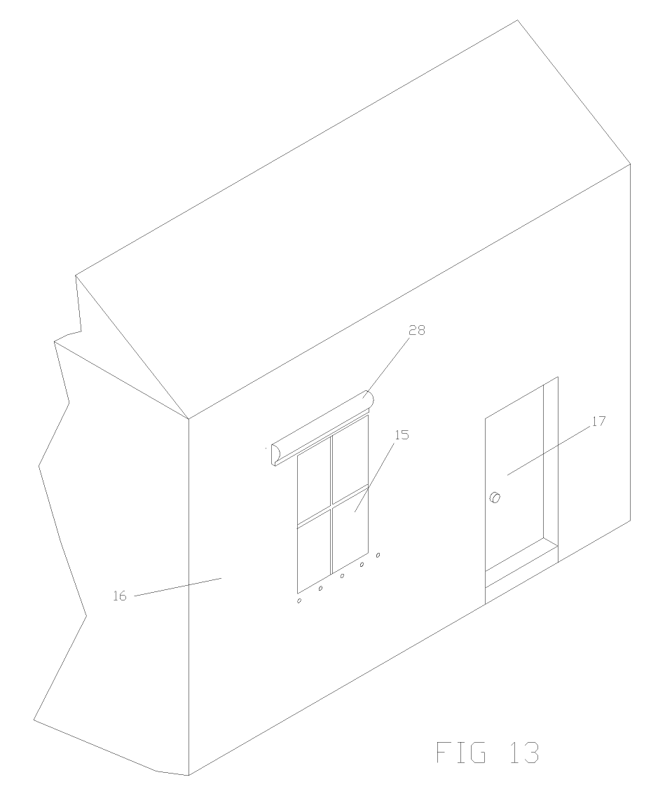

FIG. 13 is a 3 dimensional view of the protective cover assembly being stored in the assembly cover 28 over the window 15. This is what would look like when stored and put away until the next severe weather event.

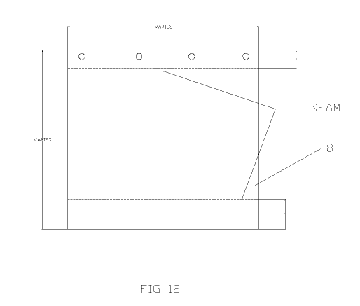

FIG. 11 is a 3 dimensional view of an alternate embodiment of an alternate method to tighten the high strength fabric over the window. In this figure, the simplified protective covering assembly is similar to FIG. 1 except rectangular bar 4 is place on the bottom and is attached to a ratcheting box which consists of fabric tube 10 placed in ratchet pull bracket 30 where the holes are located. The fabric tube 10 is connected to ratchet 14A similar to FIG. 6. The fabric tube 10 is connected to the ratchet pull cables 29 which as feed through the fabric tube 10 and tied at the end. As the fabric tube 10 is turning, the ratchet pull cables 29 are pulling down on bottom rectangular bar 4. The ratchet pull cables 29 are attached to bottom rectangular bar 4 using cable connection screws 32. The ratchet box is just temporary and is attached to the wall using anchors 11 and anchor screws 12. Once the components are in place as shown in FIG. 11, the ratchet wheel 14A is turned using ratchet handle 31 which lowers the bottom rectangular bar 4 to the predetermined location. When first installing the simplified protective covers assembly in this alternative embodiment, you will install the top rectangular bar with fabric first and then according to instruction the bottom anchors 11 will be installed below where the bottom rectangular bar 4 is located. By rotating the ratchet wheel 14A with ratchet handle, the bottom rectangular bar 4 is lowered and the user will match the holes in the rectangular bar with the bottom anchors 11. When the holes line up, anchor screws 12 will be inserted into anchors 11. The high strength fabric 8 is stretched over the window 15. The ratchet wheel 14A can be released by lifting the pawl 14B and the ratchet pull cables 29 will be loosened. By removing the cable connection screws 32 and the anchor screws 12 that connect the ratchet box to the wall, the entire assembly can be removed and used on another opening. This will provide a less expensive method of stretching the fabric.

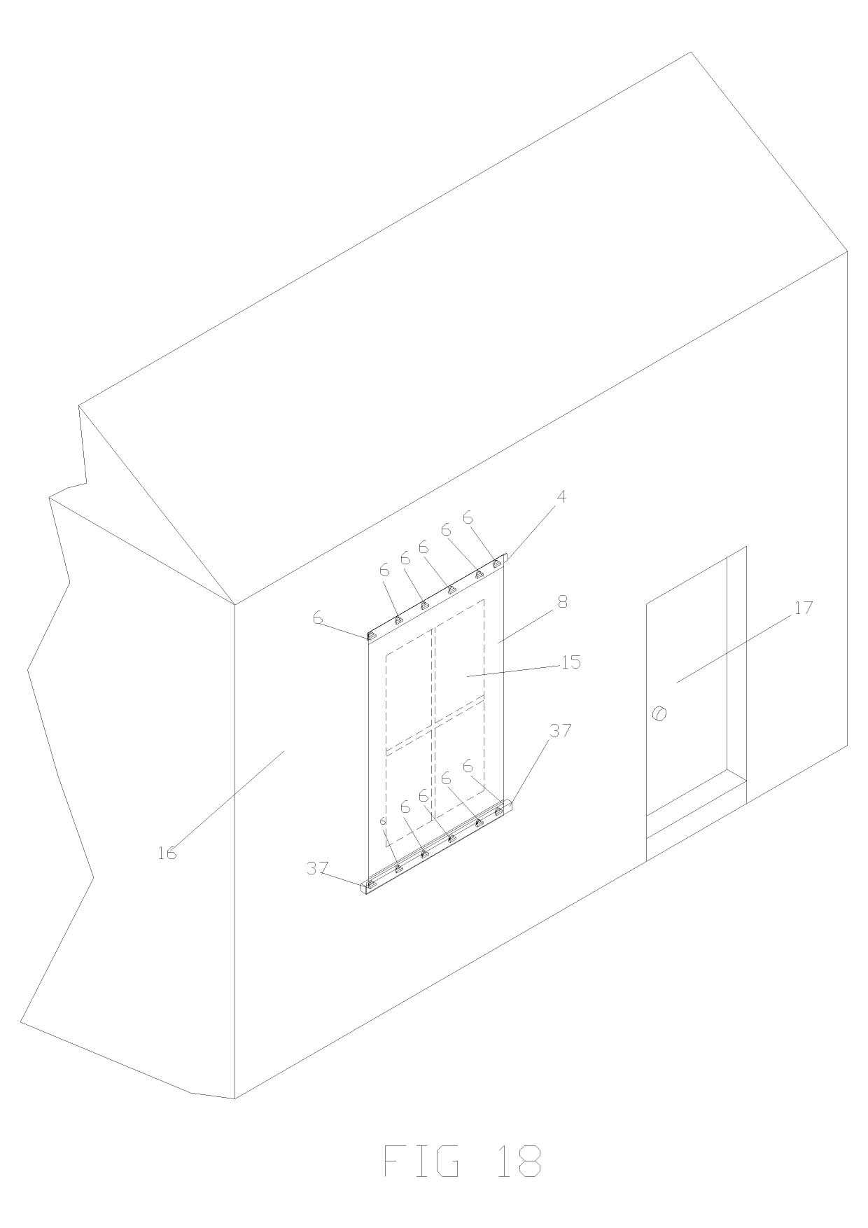

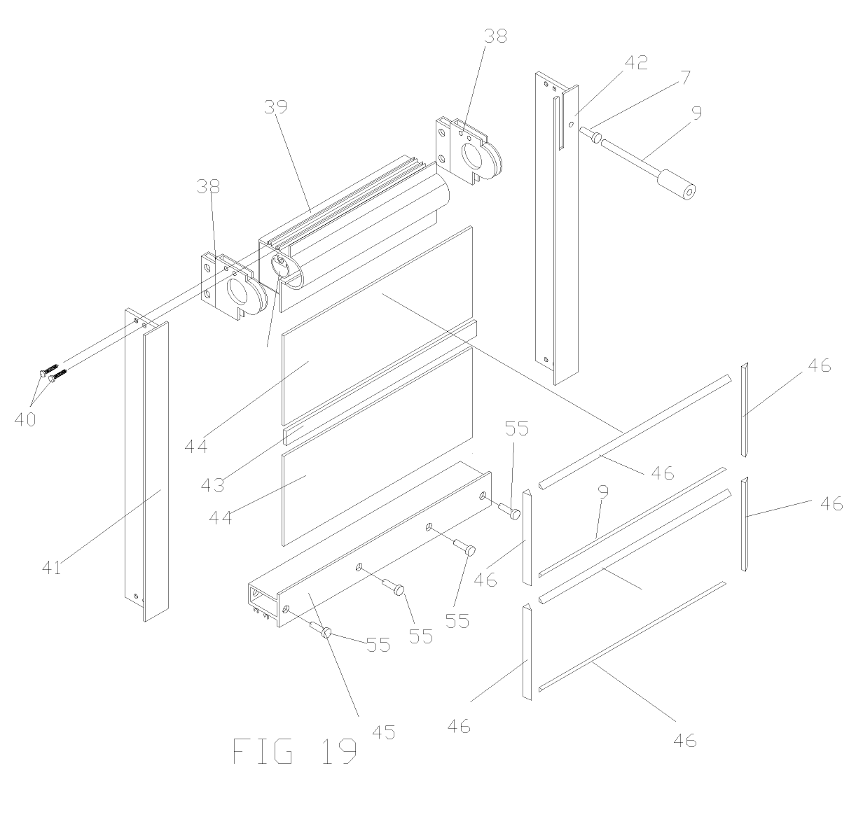

FIG. 18 is a three dimensional view of a simplier version of the simplified protective covering assembly which is similar in configuration with FIG. 11 except there is no ratchet box. The rectangular bar 4 is attached to the top of the opening and is attached to the high strength fabric 8 using a slot in the high strength fabric 8. The rectangular bar 4 and the high strength fabric 8 is attached to the wall 16 over the window 15 using bar anchors 5 and is attached using wing nuts 6. At the bottom slot in the high strength fabric 8, the heavy steel bar 37 is inserted. There are holes in the heavy steel bar 37 similar to the rectangular bar 4. The heavy steel bar 37 is heavy therefore is stretching the high strength fabric over the window. The heavy steel bar 37 is attached to the wall 16 similar to rectangular bar 4 using anchors 5 and wing nuts 6. This the alternate embodiment to stretch the fabric using weights as opposed to a device. FIG. 19 is a 3 dimensional exploded view of an window frame with integrated components to house the simplified protective covering assembly. In standard construction of aluminum windows, there are extruded parts that are connected by screws and the window pane 44 is housed within the frame when screwed together. In FIG. 19, the typical extrusions for the window structure are modified to accept the simplified protective cover assembly. The top extrusion is the Interior window assembly 39 which will house the high strength fabric 8 which is attached to the fabric tube 10 and the rectangular bar 4 is attached to the bottom of the high strength fabric and it is rolledup in side the interior window assembly 39 when not in use. On either side of the interior window assembly 39, there are interior window tube brackets 38 which will support the fabric tube 10 when inside the interior window assembly 39. On interior window tube brackets 38, there are two holes which will attach directly into the interior of the wall opening for added support for wind loads and loading on the fabric tube 10 when deployed. On the left side there is left window frame 41 which attaches to both the interior window tube brackets 38 and interior window assembly 39 by using window assembly screws 40 by screwing into the screw bossed in the interior window assembly 39. On the right side there is right window frame 42 which attaches to both the interior window tube brackets 38 and interior window assembly 39 by using window assembly screws 40 by screwing into the screw bossed in the interior window assembly 39. In the right window frame 42, there are slots and room to use the lever 9 and insert pin 7. On the bottom there is the bottom window frame 45 which attaches to the left window frame 41 using window assembly screws 40 and the right window frame 42 is attached to the bottom window frame 45 using window assembly screws 40. During the assembly of the window frames, the window pane 44 and middle window frame 43 are installed within the window frames as they would normally. Added window pane decorative attachements 46 also are placed over the window panes 44 for added support. Once the window is assembled it is ready to work. The high strength fabric 8 is pulled by rectangular bar 4 and brought down to line up the holes in the bottom window frame 45 and using window bolts 55, the retangular bar 4 with the high strength fabric 8 is attached to the window bottom frame 45. Then using the lever 9, the high strength fabric 8 is tightened and lined up with hole on the right window frame 42 and the hole in the fabric tube 10 and then insert the pin 7 similar to FIG. 3. The high strength fabric 8 is stretch and ready for the next storm. This same process could be used as a shade at night or during the day.

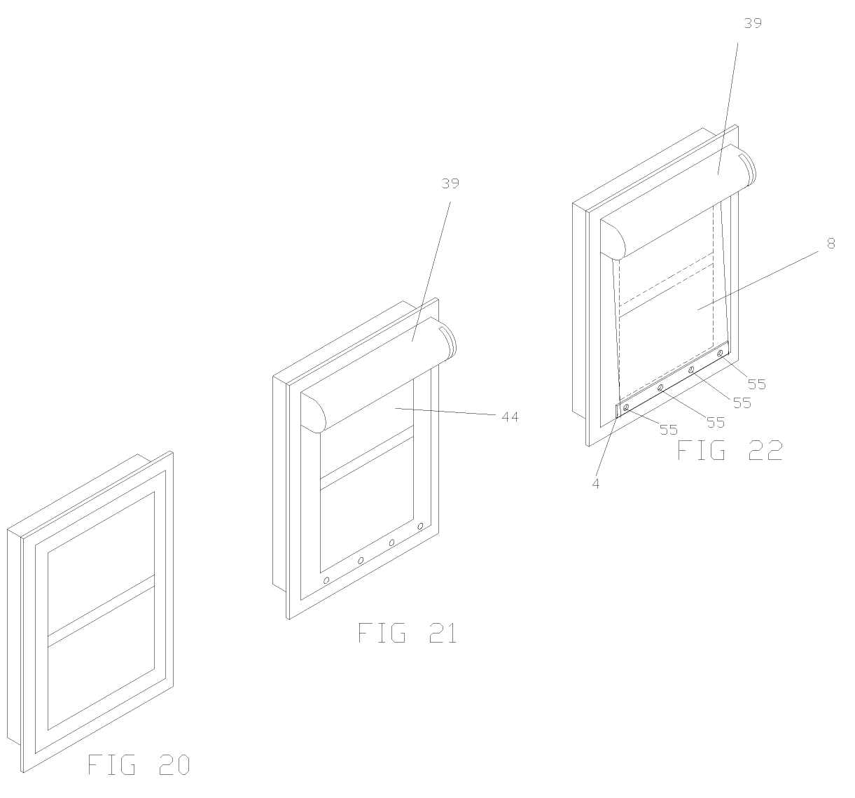

FIG. 20 is a 3 dimensional drawing of a typical window for comparision to a reengineered version with simplified protective covering assembly integrated into the window frame.

FIG. 21 is a 3 dimensional drawing of the window frame with simplified protective covering assembly integrated into the window frame in the open position or not in use position.

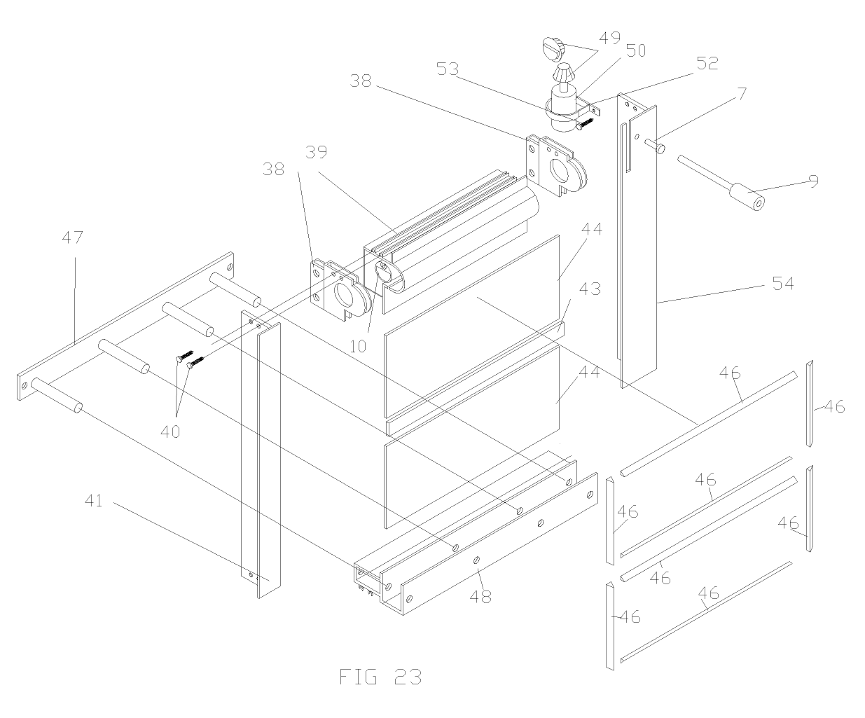

FIG. 22 is a 3 dimensional drawing of the window frame with simplified protective covering assembly integrated into the window frame in the closed position or in use position.

FIG. 23 is a 3 dimensional drawing of the window frame with simplified protective covering assembly integrated into the window frame but with a motor operator with a manual override. It is same as the FIG. 19 except the right window frame with motor compartment 54 is larger than right window frame 42 to allow room for the motor 5 which is connected to a bevel gear system 49 which is connected to the fabric tube 10 using specially made bevel gear system 49 that has the part that fits in the fabric tube 10. The motor 50 is connected to the right window frame with motor compartment 54 by using motor strap 51 and motor strap anchors 52. The bottom window frame with lip 48 is assembled the same as the bottom window frame 45. The added lip on the bottom window frame lip 48 is to allow the user to lock in the place the rectangular bar 4 in the bottom by using interior set of pins 47 that are pushed in from inside the house on the main connected shaft and is attached to the interior of wall using anchors 11 and anchor screws 12. The motor 50 will roll the high strength fabric 8 up and down and will lock into place when not in use. This will stretch the high strength fabric to the designed tension and protect the opening. As a back up incase of power failure, the original lever 9 and pin 7 will work as in FIG. 19.

The reader can see that the simplified protective cover assembly of the preferred embodiment of the invention provides a easy to use and easy to install protective cover for wall openings that is of high strength to protect against high wind and wind borne debris.

The foregoing description of the preferred embodiment of the invention has been illustrated and described for the purposes of presentation. It is not intended to be exhaustive or to limit the invention to the preferred embodiment disclosed. Many modifications and variations are possible. It is intended that the scope of the invention be limited not by this detailed description, but rather by the claims appended hereto.

I claim:

1. A simplified protective cover assembly, for the protection of openings during extreme weather conditions, comprising:
A flexible high strength material of sufficient size to cover the opening,
A rigid circular element long enough to marginally exceed the dimensions of the opening,
A rigid element long enough to marginally exceed the dimension of the opening.
A means of connecting said flexible high strength material to the said rigid circular element,
A fold in the said flexible high strength material to place the said rigid element into the said flexible high,
A bracket to hold said rigid circular element to the wall,
A device for connecting the said rigid element to the wall,
A device to rotate the said rigid circular element to stretch said flexible high strength material as the said rigid circular element is connected to the said flexible high strength material,
A device to maintain the said rigid circular element in position after the said flexible high strength fabric is stretched,
Whereby, the simplified protective cover assembly covers the opening completely and protects against wind, rain, wind borne debris and other elements associated with the severe storms.

2. A simplified protective cover assembly as set forth in claim 1, wherein the flexible high strength material is high strength fabric.

3. A simplified protective cover assembly as set forth in claim 1, wherein the rigid circular element is an extruded aluminum tube with a slot.

4. A simplified protective cover assembly as set forth in claim 1, wherein the device to connecting the said rigid circular element to the said flexible high strength material is by placing the said flexible high strength fabric into a slot in the said rigid circular element and using steel rod to keep the said flexible high strength material on the said rigid circular element.

5. A simplified protective cover assembly as set forth in claim 1, wherein the device to rotate the said rigid circular element is to use a lever that is placed in the said rigid circular element and rotated by pushing up or down at the end of the lever.

6. A simplified protective cover assembly as set forth in claim 1, wherein the device to maintain the rigid circular element in position after being rotate is to use a pin with and eyebolt that is connected to the wall and the pin is place into the said rigid circular element.

7. A simplified protective cover assembly as set forth in claim 1, wherein the device to maintain the rigid circular element in position after being rotated is using a ratchet system which has the ratchet wheel and pawl which rotate in on direction and do not reverse thus keeping the rigid circular element in position.

8. A simplified protective cover assembly as set forth in claim 1, wherein the device to maintain the rigid circular element in position after being rotated is using a permenant lever that is rotated and then locked into place with a pin and brackets.

9. A simplified protective cover assembly as set forth in claim 1, wherein the said flexible high strength material, rigid element and rigid circular element are rolled up and placed above the opening in decorative cover with hinges and cover plates to make the unit be permanently stored outdoors.

10. A simplified protective cover assembly as set forth in claim 1, where there is no rigid element but only grommets in the fabric to attache the fabric to the wall.

11. A simplified protective cover assembly as set forth in claim 1, where simplified protective cover assembly is integrated into a window frame structure where there are extrusions produced to house the said flexible high strength material, the rigid circular element and rigid element as well as brackets internally that allow the rigid circular element to rotate and pin and lever system to lock into place.

12. A simplified protective cover assembly as set forth in claim 1, wherein it can be transformed into an awning by placing supports and bracket on the wall and rolling the flexible high strength material up on the rigid circular element to specified height and locking into place with pin and then placing awning material over the flexible high strength material.

13. A simplified protective cover assembly as set forth in claim 1, wherein the rigid circular element is removed and additional rigid element including holes is replacing rigid circular element and a ratcheting box is used with cables to tighten the fabric and the pin and lever are removed.

14. A simplified protective cover assembly as set forth in claim 1, wherein the rigid circular element is removed and heavy rigid element with holes is replacing rigid circular element which through the added weight stretches the fabric to create the tensioned system.
